(19) United States
(12) Patent Application Publication
(10) Pub. No.: US 2018/0134322 A1
(43) Pub. Date: May 17, 2018

(54) HOOD OUTER CHECKING FIXTURE FEATURE

(71) Applicant: FORD GLOBAL TECHNOLOGIES, LLC, Dearborn, MI (US)

(72) Inventors: Dale E. White, Novi, MI (US); Cheryl Ann Engel, Jackson, MI (US)

(21) Appl. No.: 15/350,780

(22) Filed: Nov. 14, 2016

(51) Int. Cl. B62D 25/12; B62D 25/10

(52) U.S. Cl. CPC B62D 25/12; B62D 25/105

(57) ABSTRACT

A hood panel checking fixture feature is provided by a locator slot defined in an edge of the hood panel. The locator slot may be defined in a rear edge of the hood panel and may be configured to engage a cooperating locator provided in a checking fixture to substantially prevent rotational movement of the hood panel in a y-axis direction. Hood outer panels and methods for positioning a hood panel in a checking fixture are described.

### TECHNICAL FIELD

This disclosure relates generally to checking fixtures for motor vehicles. More particularly, the disclosure relates to a feature disposed in a hood outer panel for controlling behavior of automotive components placed in checking fixtures.

### BACKGROUND

Mass-produced components for motor vehicles must be configured in precisely defined shapes and contours according to particular vehicle models on which they will be placed to conform to design elements of other components such as fenders and the like, to present an attractive finished product to the consumer. For example, a hood outer panel may be designed for inclusion in one or more vehicle model types, and may be manufactured to include particular configuration and contours according to that vehicle model type. Ordinarily, vehicle components are mass-produced at one location, and transferred to another for final assembly to a vehicle.

Because of this, various inspections and measurements are required to ensure that a vehicle component will have the proper configuration. This is often accomplished at least in part by a checking fixture, which may include a contoured supporting surface corresponding to the desired contours and configuration of the vehicle component and various devices for ensuring that the component has the desired configuration. The checking fixture may include devices for other measurements to assure a good fit, in the example of a hood panel to assure a good fit to a vehicle engine compartment frame and other components such as fenders, including determining acceptable tolerances between the hood panel edge and, for example, front fender edges. Certain checking fixtures may even include means to simulate component fixation points to confirm that the component will perform satisfactorily when attached to brackets, hinges, etc. in an assembled vehicle. This ensures that the final product will be acceptable to the consumer.

Continuing with the example of a hood outer panel, in use the hood outer panel is placed on/in the checking fixture contoured support surface, and visually or more commonly automatically measured and analyzed for proper conformation, shape, contour, etc. For this to be successful, it is important that the component be properly located in the fixture in the x-, y-, and z-axes (relative to a vehicle orientation), and that it not be inadvertently displaced or rotate during the measurement process.

This can be done by using certain features of the hood outer panel such as washer nozzle apertures or panel side edge locators. However, many hood outer panel structures no longer include washer nozzle apertures, and the contours in modern hood outer panels often prevent satisfactorily holding the hood side edge in the checking fixture without rotation of the panel, creating motion in the y-axis during the measurement process.

Accordingly, a need is identified in the art for improvements in locating vehicle components such as hood outer panels in checking fixtures to prevent undesired movement such as rotation along a y-axis while proper conformation is determined.

### SUMMARY

In accordance with the purposes and benefits described herein, in one aspect a hood panel checking fixture locator feature is described, comprising a locator slot defined in an edge of the hood panel. The hood panel may be a hood outer panel. In embodiments, the locator slot is defined in a rear edge of the hood panel. In embodiments, the locator slot is defined in an open hem flange of the rear edge.

In embodiments, the locator slot includes two opposed substantially vertically oriented side walls, and may be configured to engage a cooperating locator provided in a checking fixture to substantially prevent rotational movement of the hood panel in a y-axis direction.

In another aspect, a hood outer panel for a vehicle hood assembly is described, comprising a panel having a front edge, two opposed side edges, and a rear edge, further including a locator slot defined in an edge of the hood panel. In embodiments, the locator slot is defined in the panel rear edge. In embodiments, the locator slot is defined in an open hem flange of the rear edge.

In embodiments, the locator slot includes two opposed substantially vertically oriented side walls, and may be configured to engage a cooperating locator provided in a checking fixture to substantially prevent rotational movement of the panel relative to the checking fixture in a y-axis direction. Hood assemblies including the checking fixture feature and vehicles including the hood assemblies are described.

In yet another aspect, a method for locating a hood panel in a checking fixture is described, comprising providing a hood panel provided with a locator slot defined in an edge thereof. A checking fixture provided with a cooperating locator configured to engage the locator slot whereby rotational movement of the hood panel in a y-axis direction is substantially prevented is also provided. The hood outer panel is then positioned in the checking fixture whereby the locator engages the locator slot. The locator slot and checking fixture locator may be as described above.

In embodiments, the locator slot may be defined having at least two opposed substantially vertically oriented side walls. In embodiments, the locator slot may be provided defining a quadrilateral cross-section. Likewise, in embodiments the locator may be provided defining a quadrilateral cross-section. The hood panel may be a hood outer panel.

In the following description, there are shown and described several preferred embodiments of the described hood panel checking fixture feature and methods for positioning a hood panel in a checking fixture using same. As it should be realized, the feature is capable of other, different embodiments and its several details are capable of modification in various, obvious aspects all without departing from the hood panel checking fixture feature and associated methods as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the hood panel checking fixture feature and together with the description serve to explain certain principles thereof. In the drawing figures:

FIG. 1 shows a vehicle including a hood assembly comprising a contoured hood outer panel;

FIG. 2 depicts an embodiment of a hood outer panel checking fixture feature according to the present disclosure; and

FIG. 3 depicts the hood outer panel checking fixture feature of FIG. 1, engaged by a cooperating locator in a hood checking fixture.

Reference will now be made in detail to the present preferred embodiments of the hood panel checking fixture feature and associated methods, examples of which are illustrated in the accompanying drawing figures.

### DETAILED DESCRIPTION

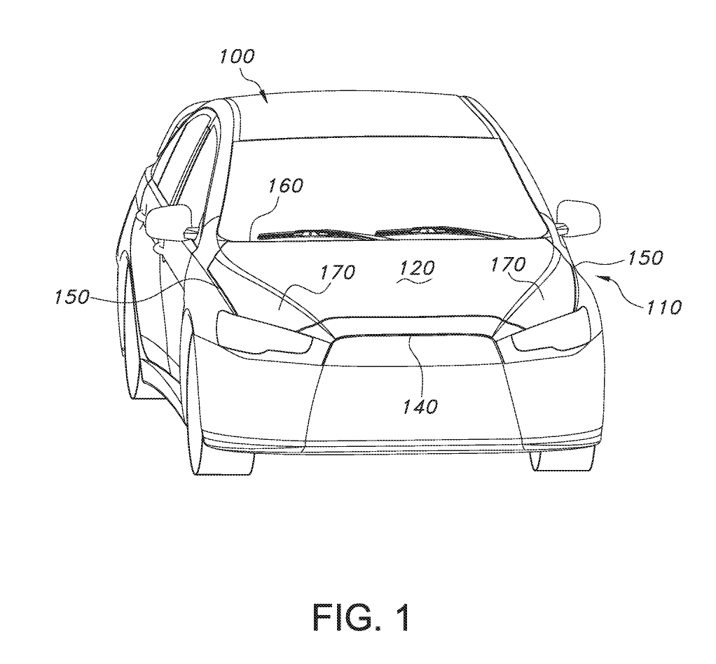

Reference is now made to FIG. 1 illustrating a vehicle 100 including a hood assembly 110 having a hood outer panel 120. It will be appreciated that the hood assembly 110 also includes a hood inner panel (not visible in this view) which attaches to the hood outer panel 120 and may include various stiffening structures, may define crumple zones, etc. The hood outer panel 120 as shown is defined by a panel 130 having a front edge 140, two opposed side edges 150, and a rear edge 160. The hood outer panel 120 as shown also may include various design elements such as contours 170.

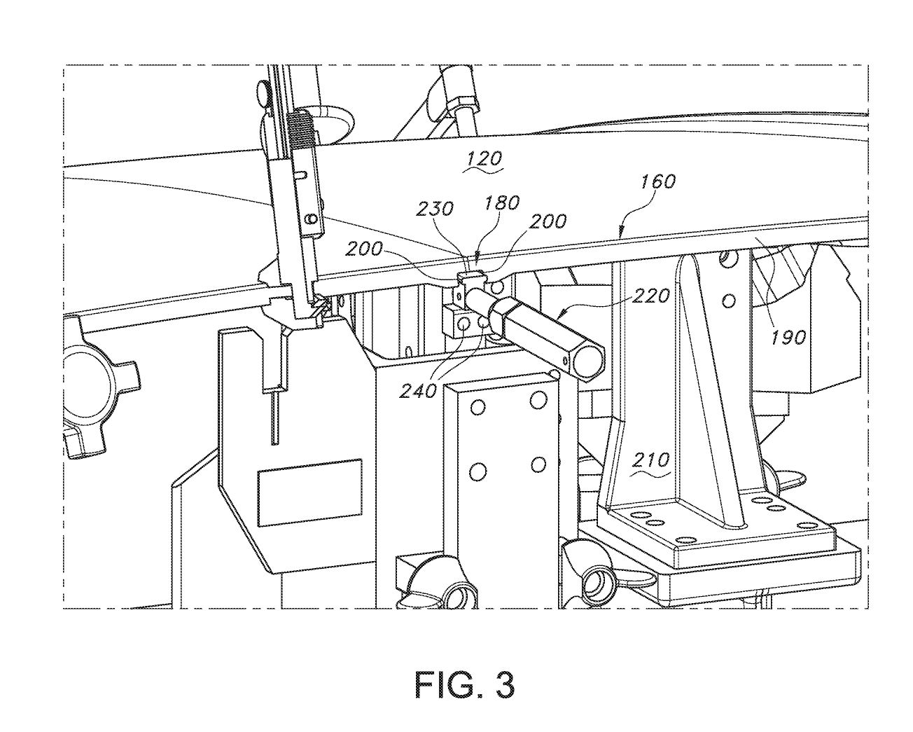

As described above, a hood outer panel 120 may be designed for inclusion in one or more vehicle 100 model types, and may be mass-produced at one location to include particular configuration and contours according to that vehicle model type and transferred to another for final assembly to a vehicle. Therefore, various inspections and measurements are required to ensure that the hood outer panel 120 will have the proper configuration, which is often done at least in part by a checking fixture 210 (see FIG. 3) having a contoured supporting surface (not visible in this view) corresponding to the desired contours and configuration of the hood outer panel and various devices for ensuring that the panel has the desired configuration before being assembled to a vehicle 100.

For checking, the hood outer panel 120 is placed on/in the checking fixture 210 contoured support surface (not visible in this view), and visually or more commonly automatically measured and analyzed for proper conformation, shape, contour, etc. For this to be successful, it is important that the component be properly located in the fixture in the x-, y-, and z-axes (relative to a vehicle orientation), and that it not be inadvertently displaced or rotate during the measurement process. Prior art systems utilize certain features of the hood outer panel 120 such as washer nozzle apertures or panel side edge locators. However, many hood outer panel 120 structures no longer include washer nozzle apertures, and the contours in modern hood outer panels often prevent satisfactorily holding the hood side edge in the checking fixture 210 without rotation of the panel, creating motion in the y-axis during the measurement process.

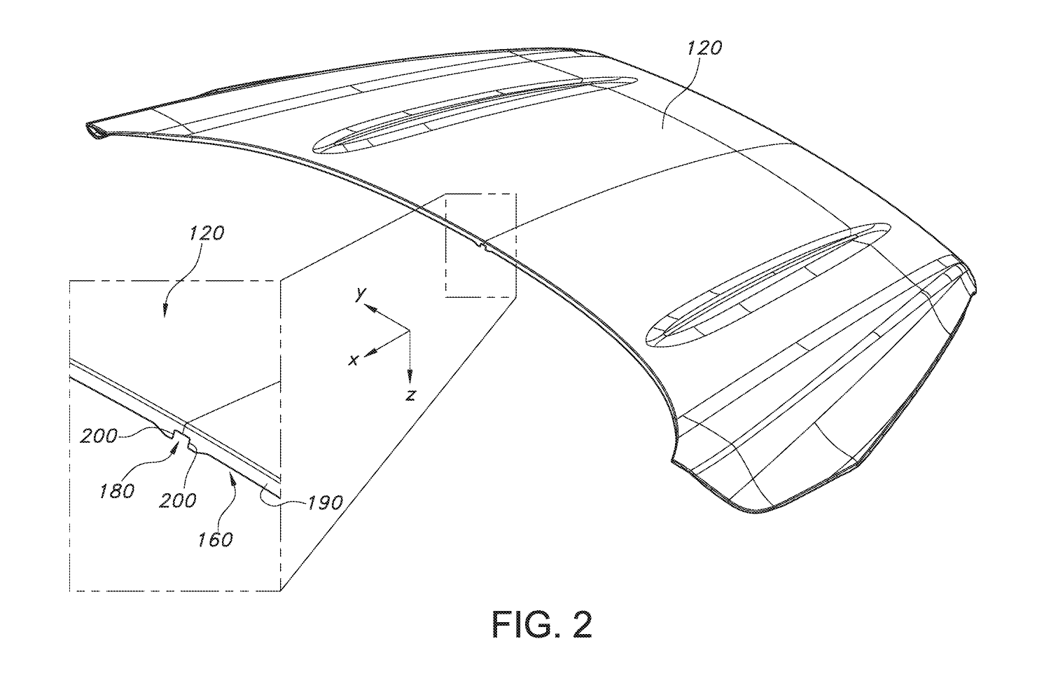

To solve this and other problems, with reference to FIG. 2 there is provided a hood outer panel 120 having a checking fixture locator feature provided by a locator slot 180 defined in the rear edge 160 of the panel. In the depicted embodiment, the locator slot 180 is defined in an open hem flange 190 of the panel rear edge 160, which as will be appreciated disposes the locator slot in an area not visible to the customer in the assembled hood assembly 110.

In the depicted embodiment, the locator slot 180 includes at least opposed side walls 200 that are substantially vertically oriented, i.e. substantially coplanar with a vehicle z-axis. As shown, the locator slot 180 defines a quadrilateral shape in cross-section. The locator slot 180 is configured to engage a cooperating locator (not shown in this view) held in a checking fixture 210. By the substantially vertically oriented opposed side walls 200, rotation of the hood outer panel 120 along the panel y-axis is prevented when the panel is placed in the checking fixture 210 as will be discussed.

With reference to FIG. 3, the checking fixture 210 includes a cooperating locator 220, at least a portion 230 of which is dimensioned and configured to engage the locator slot 180 as shown. The locator 220 may be integral to the checking fixture 210, or may be configured for attaching by way of fasteners 240 to different portions of the checking fixture in accordance with the dimensions and/or configuration of the particular hood outer panel 120 being examined. As can be seen from the drawing figure, the locator portion 230 snugly engages at least the locator slot side walls 200, similar to the engagement of a wrench and a nut, sufficiently to prevent undesired rotation of the hood outer panel 120 when positioned in the checking fixture 210. Thus, proper positioning of the hood outer panel 120 in the checking fixture 210 is ensured, and also rotation along the hood outer panel y-axis is prevented. This ensures that subsequent measurements done in and by the checking fixture 210 will be accurate and to specification.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A hood panel checking fixture locator feature, comprising a locator slot defined in an edge of the hood panel.

2. The hood panel checking fixture locator feature of claim 1, wherein the locator slot is defined in a rear edge of the hood panel.

3. The hood panel checking fixture locator feature of claim 2, wherein the locator slot is defined in an open hem flange of the rear edge.

4. The hood panel checking fixture locator feature of claim 1, wherein the locator slot includes two opposed substantially vertically oriented side walls.

5. The hood panel checking fixture locator feature of claim 4, wherein the locator slot is configured to engage a cooperating locator provided in a checking fixture to substantially prevent rotational movement of the hood panel in a y-axis direction.

6. The hood panel checking fixture locator feature of claim 1, wherein the hood panel is a hood outer panel.

7. A hood outer panel for a vehicle hood assembly, comprising a panel having a front edge, two opposed side edges, and a rear edge, further including a locator slot defined in an edge of the panel.

8. The hood outer panel of claim 7, wherein the locator slot is defined in the panel rear edge.

9. The hood outer panel of claim 8, wherein the locator slot is defined in an open hem flange of the rear edge.

10. The hood outer panel of claim 7, wherein the locator slot includes two opposed substantially vertically oriented side walls.

11. The hood outer panel of claim 10, wherein the locator slot is configured to engage a cooperating locator provided in a checking fixture to substantially prevent rotational movement of the hood outer panel in a y-axis direction.

12. A vehicle hood assembly including the hood outer panel of claim 7.

13. A vehicle including the hood assembly of claim 12.

14. A method for locating a hood panel in a checking fixture, comprising:
providing a hood panel provided with a locator slot defined in an edge thereof;
providing a checking fixture provided with a cooperating locator configured to engage the locator slot whereby rotational movement of the hood panel in a y-axis direction is substantially prevented; and
positioning the hood panel in the checking fixture whereby the locator slot engages the locator.

15. The method of claim 14, including providing the locator slot in a rear edge of the hood panel.

16. The method of claim 15, including providing the locator slot in an open hem flange of the rear edge.

17. The method of claim 14, including providing the locator slot having at least two opposed substantially vertically oriented side walls.

18. The method of claim 17, including providing the locator slot defining a quadrilateral cross-section.

19. The method of claim 18, including providing the locator having a quadrilateral cross-section.

20. The method of claim 14, including providing the hood panel as a hood outer panel.
